(19) United States
(12) Patent Application Publication
(10) Pub. No.: US 2019/0341614 A1
(43) Pub. Date: Nov. 7, 2019

(54) PERFLUOROPOLYETHER ADDITIVES FOR LITHIUM ION BATTERY ANODES

(71) Applicant: FORD GLOBAL TECHNOLOGIES, LLC, Dearborn, MI (US)

(72) Inventors: ANDREW ROBERT DREWS, ANN ARBOR, MI (US); KEVIN WUJCIK, BERKELEY, CA (US)

(21) Appl. No.: 15/968,886

(22) Filed: May 2, 2018

(51) Int. Cl. H01M 4/62; H01M 10/0525; H01M 4/38; H01M 4/587; H01M 4/36; H01M 10/0567

(52) U.S. Cl. CPC H01M 4/62; H01M 10/0525; H01M 4/386; H01M 2004/027; H01M 4/364; H01M 10/0567; H01M 4/587

(57) ABSTRACT

A lithium ion battery includes a cathode, an anode including a silicon-based active material, a separator between the anode and the cathode, a liquid electrolyte, and an elastic and hydrophobic solid-electrolyte interphase layer between and in contact with the anode and electrolyte. Further, the electrolyte or a surface of the anode includes a perfluoropolyether compound. A method of forming a lithium ion battery includes cycling the battery, that includes a cathode, an anode having a silicon-based active material, a perfluoropolyether compound, and an electrolyte, to prompt formation of an elastic and hydrophobic solid-electrolyte interphase layer including the perfluoropolyether compound and between and in contact with the electrolyte and a surface of the anode.

### TECHNICAL FIELD

The present disclosure relates to lithium ion battery cells, and more particularly, to stabilizing the active material in lithium ion battery anodes.

### BACKGROUND

Lithium ion battery anodes contain an active material that stores lithium ions. The active material most commonly used is graphite, which has a specific capacity of 372 mAh/g. The volumetric and gravimetric energy density of lithium ion batteries may be increased by adding silicon to the battery anode. Compared to graphite, silicon has a specific capacity of 4200 mAh/g and can bind over 4 lithium ions per silicon atom. Given this increase in specific capacity and that silicon is both inexpensive and naturally abundant, integration of silicon into lithium ion battery anodes is an attractive alternative to graphite for the next generation of lithium ion battery cells.

In lithium ion batteries, a porous solid electrolyte interphase (SEI) layer forms on the surface of the active material through electrochemical and chemical reactions between the lithium ions, electrolyte solvent, electrolyte salts, electrons, binder molecules, the surface of the active material, and/or any combination of these components. Although formation of the SEI layer may consume the lithium ions and may increase cell resistance, the SEI layer is typically stabilized during the first few battery cycles. Although the SEI layer is porous to lithium ions, it ideally becomes non-porous to electrolyte molecules as it grows, ultimately limiting the electrolyte diffusion to the active material surface leading to further SEI growth.

Including silicon in lithium ion battery anodes may introduce performance degradation issues due to the poor stability of the SEI on silicon particles. When silicon is fully alloyed with lithium, it undergoes a large expansion (>300%), with respect to the unlithiated silicon. When lithium ions are removed from the silicon, the material may then contract to about its original size. The cyclical expansion and contraction of the silicon may lead to fracture and reformation of the SEI layer. When the SEI layer is fractured upon charging, a fresh silicon surface may be exposed, leading to renewed surface reactions forming a new SEI layer. This process may continuously and irreversibly consume electrolyte and lithium, and may further introduce new reaction products that are detrimental to cell performance.

### SUMMARY

According to an embodiment, a lithium ion battery includes a cathode, an anode including a silicon-based active material, a separator between the anode and the cathode, a liquid electrolyte, and an elastic and hydrophobic solid-electrolyte interphase layer between and in contact with the anode and electrolyte. Further, the electrolyte or a surface of the anode includes a perfluoropolyether compound.

According to one or more embodiments, the perfluoropolyether compound may be reactive with the silicon active material surface or solid-electrolyte interphase layer to form reaction products in the layer. Furthermore, the perfluoropolyether compound may polymerize, forming a component of the layer. In one or more embodiments, the perfluoropolyether compound may be non-reactive with the solid-electrolyte interphase layer. In some embodiments, the perfluoropolyether compound may have formula (I):

R₁—(CF₂CF₂O)ₚ—(CF₂O)_{q}—R₂ (I)

wherein R₁ and R₂ are each, independently, —H, —OH, C₁₋₈ alkyl, halo, carbonate, cyano, nitrile, amide, amine, acryl, or a fluorinated group, and p and q are each, independently, an integer from 1 to 12. In one or more embodiments, the silicon-based active material may be silicon, silicon monoxide, a silicon alloy, or a carbon silicon nanocomposite configured to store lithium ions. According to an embodiment, the perfluoropolyether compound may be disposed on the surface of the active material by a pre-treatment of the active material. In another embodiment, the perfluoropolyether compound may be an additive in the electrolyte.

According to one or more embodiments, a lithium ion battery anode includes a silicon-based active material having a surface, a solid-electrolyte interphase layer in contact with the surface and an electrolyte; and a perfluoropolyether compound in at least one of the surface and the electrolyte. The perfluoropolyether compound is reactive with the active material surface and/or the solid-electrolyte interphase layer to facilitate formation of the layer.

According to one or more embodiments, the perfluoropolyether compound may be configured to participate in polymerization of organic compounds in the layer. In some embodiments, the perfluoropolyether compound may be configured to react with the silicon containing active material particles and form reaction products in the solid-electrolyte interphase layer. In one or more embodiments, the silicon-based active material may be silicon, silicon monoxide, a silicon alloy, or a carbon silicon nanocomposite configured to store lithium ions. In an embodiment, the perfluoropolyether compound may be included in the electrolyte.

According to an embodiment, a method of forming a lithium ion battery includes cycling the battery, that includes a cathode, an anode having a silicon-based active material, a perfluoropolyether compound, and an electrolyte, to prompt formation of an elastic and hydrophobic solid-electrolyte interphase layer including the perfluoropolyether compound and between and in contact with the electrolyte and a surface of the anode.

According to one or more embodiments, the perfluoropolyether compound may have formula (II):

R₁—(CF₂CF₂O)ₚ—(CF₂O)_{q}—R₂ (II)

wherein R₁ and R₂ are each, independently, —H, —OH, C₁₋₈ alkyl, halo, carbonate, cyano, nitrile, amide, amine, acryl, or a fluorinated group, and p and q are each, independently, an integer from 1 to 12. In some embodiments, the perfluoropolyether compound may react at the surface of the silicon containing active material particles or with components of the layer and thus may modify the elasticity, hydrophobicity, ionic conductivity, or structure of the layer. In an embodiment, the method may further include pre-treating the anode to deposit the perfluoropolyether compound on a surface of the silicon-based active material. In another embodiment, the method may further include adding the perfluoropolyether compound to the electrolyte to be incorporated into or reactive with the layer during cycling. In some embodiments, the method may further include decomposing the perfluoropolyether compound at a surface of the silicon-based active material to form products in the layer or polymerized perfluoropolyether compound in the layer. In one or more embodiments, the perfluoropolyether compound may be non-reactive with the solid-electrolyte interphase layer.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Stabilization of SEI layer growth on lithium-silicon anodes may be significantly improved by adding fluoroethylene carbonate (FEC) and vinylene carbonate (VC) to the electrolyte. These additives may preferentially decompose on the surface of the silicon particle surfaces, thus forming free radical species that may promote solvent polymerization. Solvent polymerization may improve the elasticity and stability of the SEI layer. Modifying the elasticity of the SEI may help accommodate the expansion and contraction of the material during charge and discharge. The resulting products of FEC and VC decomposition may be relatively chemically stable, and may help prevent further electrolyte breakdown and consumption of lithium. As such, FEC and VC are useful in extending cell life and may increase usable cell capacity.

Furthermore, one byproduct of the reaction of the lithium ions with the fluorine atoms of FEC and the electrolyte salt (LiPF₆) is lithium fluoride (LiF). LiF is an inorganic species that passivates the silicon surface and mitigates further SEI formation. Overall, the presence of LiF in the SEI layer promotes anode stability.

In addition to fracture of the SEI during cycling, the SEI layer and the active material may break down due to hydrofluoric acid (HF) attack. This breakdown further contributes to the instability of the SEI layer and poor cell performance. HF may be formed via the reaction of the electrolyte salt, LiPF₆, with water. Water may be present in lithium ion cells for a number of reasons. For example, liquid electrolytes may have trace amounts of water, cell materials may absorb water when exposed to air during cell preparation (e.g., hygroscopic materials), or water may be formed through degradative chemical reactions within the cell and during formation of the SEI layer in the anode. The presence of water and LiPF₆ in the anode may lead to the formation of HF that can etch through the SEI layer and/or react with silicon, rendering it inactive. As described above, the breakdown of the SEI layer may lead to the formation of a new SEI layer, which consumes electrolyte and lithium, slowly reducing the amount of lithium available within the cell and causing the usable battery capacity to fade.

According to embodiments of the present disclosure, a lithium ion battery is disclosed. The lithium ion battery includes an anode and cathode, which are separated by a separator. The anode includes silicon as an active material. The anode may include another material in addition to silicon, and thus may be, for example, a silicon-based active material. The silicon in the anode may be a high-density compound of silicon which expands upon reacting with lithium. The silicon may also be any type of nano-scale or micro-scale silicon particles/solid. For example, the silicon-based active material may include, but is not limited to, silicon, silicon monoxide, a silicon alloy, or a carbon silicon nanocomposite configured to store lithium ions. The anode further includes an SEI layer formed on the surface of the active material. The battery also includes a liquid electrolyte. Any suitable liquid electrolyte may be selected based on the active materials and separator. The liquid electrolyte may be composed of a solvent and a lithium containing salt. In some embodiments, the solvent is a mixture of compounds that may serve to improve the solubility of the salt, decrease viscosity, or to selectively react on the surface of the active materials and form SEI components favorable to the life of the battery.

The lithium ion battery of the present disclosure further includes a perfluoropolyether (PFPE) compound. The PFPE compound may be used as an additive to improve the elasticity and stability of the SEI layer. In an embodiment, the PFPE additive is included in the electrolyte. In another embodiment, the PFPE additive is pretreated onto the surface of the active material, where it reacts with the electrolyte during formation of the SEI layer. By including a PFPE additive, the SEI layer may have improved elasticity for the expansion and contraction of active materials; may include a chemically stable species that, after formation, may resist further decomposition; may contain inorganic LiF for stabilizing SEI layer growth formed through the breakdown of fluorine-containing species like FEC or LiPF₆; and may have improved hydrophobicity such that water diffusion and formation of HF is inhibited.

The PFPE additive may be any suitable PFPE molecule selected to interact with the SEI layer based on the electrolyte selection and silicon requirements. PFPEs are a class of fluorinated polymeric materials that are liquid at room temperature and traditionally used as lubricants in applications where chemical, thermal and electrical resistance, and nonflammability, are critical. PFPEs are typically used as anticorrosion and antifouling additives due to their chemical stability and hydrophobicity, which can be attributed to the fluorinated backbone of the PFPE compound. Because the chemical structure of PFPE can vary depending on complexity and choice of terminal group, PFPE may have structures such as, but not limited to, branched backbones or a linear backbones. An example of a linear PFPE chemical structure is shown below:

R₁—(CF₂CF₂O)ₚ—(CF₂O)_{q}—R₂

Terminal groups R₁ and R₂ may each, independently, be —H, —OH, C₁₋₈ alkyl, halo, carbonate, cyano, nitrile, amide, amine, acryl, or a fluorinated group (e.g., CF₃), and p and q are each, independently, an integer from 1 to 12. Terminal groups R₁ and R₂ may be selected to be the same, or may be selected to be different, depending on the properties of the SEI layer desired, what chemical by-products are desired, and desired integration with the SEI layer. The PFPE may be selected to control the chemical or electrochemical reactions between the terminal groups of the PFPE molecules and the silicon active material surface during pretreatment or during SEI formation. In some embodiments, the terminal group is selected such that it may participate in the polymerization and/or crosslinking of PFPE in the SEI layer. The PFPE's participation in polymerizing the layer may include, but is not limited to, polymerizing itself in the layer, or acting to enhance polymerization of the electrolyte solvent molecules. Additionally, the PFPE may be reactive with the silicon active material surface. In other embodiments, the PFPE additive may be reactive with the solid-electrolyte interphase layer to form reaction products in the layer, or non-reactive in instances where the terminal groups are inert. In other embodiments, the terminal group may be a fluorinated terminal group, rendering the PFPE relatively inert. PFPE molecules that may be utilized include commercially available PFPEs such as, but not limited to, Fluorolink E10-H, Fomblin Y, and Fomblin Z. As noted above, the PFPE may be a branched backbone PFPE, which is commercially available as Fomblin Y. Some non-limiting examples of terminal groups that may participate in condensation reactions that form water, and thus would not be ideal, are alcohols, such as found in Fluorolink E10-H. As previously discussed, water formation can be detrimental to cell performance and cycle life. Furthermore, the terminal groups may be selected based on the PFPE solubility in the electrolyte. Depending on the electrolyte selection, the PFPE may need to be either physically or chemically, or both physically and chemically, soluble in the electrolyte. The solubility of the PFPE can thus be modified by selecting electrolyte soluble terminal groups.

In an embodiment, the PFPE is chemically attached to the surface of the silicon-containing active material particles via pretreatment of the silicon-containing active material either before, or after electrode fabrication by a surface-modifying PFPE agent. An example of a suitable surface-modifying pretreatment is Fluorolink S10, which is terminated with a triethoxysilane group such that hydrophobicity, chemical stability, and density of fluorine near the active material surface is improved. In this example, attachment of the PFPE molecules to the surface of silicon is achieved by first reacting the silicon material's surface with a mixture of hydrogen peroxide and sulfuric acid, which coats the silicon surface with hydroxyl group, forming an Si—OH bond. Hydroxyl groups can then react with the triethoxysilane terminal group of the Fluorolink S10, thereby tethering the PFPE to the silicon surface. The PFPE pre-treated silicon will improve the elasticity and chemical stability of the SEI layer as it forms during cell cycling because of the incorporation of the fluorinated backbone chain into the SEI layer, while providing the hydrophobic benefits previously discussed.

In another embodiment, the PFPE may be added to the liquid electrolyte in the cell. The PFPE additive may be selected based on the liquid electrolyte chemistry of the lithium ion battery. The terminal groups of the PFPE additive may in-turn be selected based on the electrolyte chemistry, such as the selected electrolyte ions, and desired SEI layer properties. The PFPE additive may react spontaneously with the silicon particle surface in the electrode without requiring the use of pretreatments to functionalize the surface of the silicon particles. As an additive to the liquid electrolyte, the PFPE may react with the SEI layer of the exposed silicon surfaces preferentially, or with other SEI components, such as, for example, reaction intermediates present during SEI formation. By incorporating the PFPE additive in the liquid electrolyte, integration of the PFPE into the SEI layer may occur during SEI layer formation or during cycling as the reactions occur. Integration of the PFPE during cycling would continuously introduce the PFPE chains, and depositing LiF by-product into the SEI layer, to improve anode stability.

According to one or more embodiments, the PFPE may be included in the lithium ion battery as either an additive in the electrolyte for cells with silicon-containing anodes, or as an electrode pretreatment. The PFPE will provide chemical stability, elasticity, and HF resistance for the SEI layer. Because of the chemically stable and polymeric nature of the fluorinated backbone of the PFPE, the presence of PFPE in the SEI layer of silicon anodes will impact chemical stability and elasticity. Furthermore, since PFPE is hydrophobic, an SEI layer that is in contact with PFPE, either via the electrolyte additive or the electrode pretreatement, may repel water molecules, thus preventing HF formation and etching of the SEI layer and silicon active material. Moreover, the surface reaction at the SEI layer with the selected terminal group may leave the fluorinated backbone of the PFPE intact, providing other benefits. If the PFPE backbone does chemically breakdown during SEI formation, the high atomic density of fluorine along the PFPE molecule's backbone may enhance formation of LiF, which helps improve SEI composition by mitigating SEI layer growth.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lithium ion battery comprising:
a cathode;
an anode including a silicon-based active material;
a separator between the anode and the cathode;
a liquid electrolyte; and
an elastic and hydrophobic solid-electrolyte interphase layer between and in contact with the anode and electrolyte, wherein the electrolyte or a surface of the anode includes a perfluoropolyether compound.

2. The lithium ion battery of claim 1, wherein the perfluoropolyether compound is reactive with the solid-electrolyte interphase layer to form reaction products in the layer.

3. The lithium ion battery of claim 2, wherein the perfluoropolyether compound polymerizes the layer.

4. The lithium ion battery of claim 1, wherein the perfluoropolyether compound is non-reactive with the solid-electrolyte interphase layer.

5. The lithium ion battery of claim 1, wherein the perfluoropolyether compound has formula (I):
R₁—(CF₂CF₂O)ₚ—(CF₂O)_{q}—R₂ (I)
wherein R₁ and R₂ are each, independently, —H, —OH, C₁₋₈ alkyl, halo, carbonate, cyano, nitrile, amide, amine, acryl, or a fluorinated group, and p and q are each, independently, an integer from 1 to 12.

6. The lithium ion battery of claim 1, wherein the silicon-based active material is silicon, silicon monoxide, a silicon alloy, or a carbon silicon nanocomposite configured to store lithium ions.

7. The lithium ion battery of claim 1, wherein the perfluoropolyether compound is disposed on the surface of the active material by a pre-treatment of the active material.

8. The lithium ion battery of claim 1, wherein the perfluoropolyether compound is an additive in the electrolyte.

9. A lithium ion battery anode comprising:
a silicon-based active material having a surface;
a solid-electrolyte interphase layer in contact with the surface and an electrolyte; and
a perfluoropolyether compound in at least one of the surface and the electrolyte and reactive with the solid-electrolyte interphase layer to facilitate formation of the layer.

10. The lithium ion battery anode of claim 9, wherein the perfluoropolyether compound is configured to participate in polymerization of the layer.

11. The lithium ion battery anode of claim 9, wherein the perfluoropolyether compound is configured to react and form reaction products in the solid-electrolyte interphase layer.

12. The lithium ion battery anode of claim 9, wherein the silicon-based active material is silicon, silicon monoxide, a silicon alloy, or a carbon silicon nanocomposite configured to store lithium ions.

13. The lithium ion battery anode of claim 9 wherein the perfluoropolyether compound is included in the electrolyte.

14. A method of forming a solid-electrolyte interphase layer in a lithium ion battery, comprising:
cycling the battery, that includes a cathode, an anode having a silicon-based active material, a perfluoropolyether compound, and an electrolyte, to prompt formation of an elastic and hydrophobic solid-electrolyte interphase layer including the perfluoropolyether compound and between and in contact with the electrolyte and a surface of the anode.

15. The method of forming the lithium ion battery of claim 14, wherein the perfluoropolyether compound has formula (II):
R₁—(CF₂CF₂O)ₚ—(CF₂O)_{q}—R₂ (II)
wherein R₁ and R₂ are each, independently, —H, —OH, C₁₋₈ alkyl, halo, carbonate, cyano, nitrile, amide, amine, acryl, or a fluorinated group, and p and q are each, independently, an integer from 1 to 12.

16. The method of forming the lithium ion battery of claim 14, wherein the perfluoropolyether compound reacts with the layer and modifies the elasticity, hydrophobicity, ionic conductivity, or structure of the layer.

17. The method of forming the lithium ion battery of claim 14, further comprising pre-treating the anode to deposit the perfluoropolyether compound on a surface of the silicon-based active material.

18. The method of forming the lithium ion battery of claim 14, further comprising adding the perfluoropolyether compound to the electrolyte to be incorporated into or reactive with the layer during cycling.

19. The method of forming the lithium ion battery of claim 14, further comprising decomposing the perfluoropolyether compound at a surface of the silicon-based active material to form products in the layer or polymerize the layer.

20. The method of forming the lithium ion battery of claim 14, wherein the perfluoropolyether compound is non-reactive with the solid-electrolyte interphase layer.
